(19) United States
(12) Patent Application Publication
(10) Pub. No.: US 2014/0076962 A1
(43) Pub. Date: Mar. 20, 2014

(54) NETWORK LINKED DATA CARRIERS FOR COLLECTIBLES

(71) Applicants: Barry J. Lipsky, Princeton Junction, NJ (US); Pang Lee, Tseung Kwan O (HK)

(72) Inventors: Barry J. Lipsky, Princeton Junction, NJ (US); Pang Lee, Tseung Kwan O (HK)

(73) Assignee: FRANKLIN ELECTRONIC PUBLISHERS, INCORPORATED, Burlington, NJ (US)

(21) Appl. No.: 13/621,386

(22) Filed: Sep. 17, 2012

(51) Int. Cl. G06F 17/30

(52) U.S. Cl. 235/375

(57) ABSTRACT

A method for sharing among a plurality of collectors certain information related to collectable items in the form of digital audio files in order to facilitate the reading aloud of audio messages associated with a unique data carrier on a collectible item using at least one handheld electronic aid, at least one computer, at least one server, and a network by which said computers and servers are integrated.

### FIELD OF THE INVENTION

The present invention relates in general to data carriers for use with a handheld electronic aid adapted for reading aloud information stored in the electronic aid correlated to an identifier printed on the data carrier and an improvement in the use of such an electronic reading aloud system based in part on a method for sharing such information for use by geographically disparate users by linking data carriers through the medium of a network of computers, such as the World Wide Web, for the purpose of annotating or identifying collectible items, such as stickers or cards imprinted with photographs of sports figures, by way of audible information.

### BACKGROUND OF THE INVENTION

Data carriers, adapted to be read by a handheld electronic aid capable of reading an identifier printed on the data carrier, are found in commerce such as those used in connection with the electronic aid sold under the mark AnyBook™ by Franklin Electronic Publishers, Inc. Data carriers can typically take the form of labels. Data carriers can also be printed directly onto a variety of items, such as paper or plastic products, specifically sports trading stickers or cards, for example. Identifiers can take the form of one or more patterns of dots on the data carrier that may be too small to be visually perceived by a human reader, but can be read by an electronic aid adapted for that purpose. In other circumstances, the identifiers can be printed with various inks in the visual spectrum or the ultra violet spectrum. Identifiers can be printed in a grid pattern with an x and y axis. Alternatively, identifiers can be printed in a radial pattern. Identifiers can also be printed in various other patterns and techniques commonly used in the art. Often, a plurality of identifiers is found on a single data carrier, thereby permitting the electronic aid to read the identifier at any number of places on the surface of a data carrier. In many instances, the electronic aid uses reference points on the identifier to read the identifier in any rotational orientation through the use of a software algorithm.

Data carriers capable of being read by the use of a handheld electronic aid can be used for various purposes. One common application generally involves the use of a data carrier that is affixed to an item, such as a container of medicine or the page of a book. The information to be read aloud may be, in the case of the container of medicine, an audio clip corresponding to a the name of a medication, the dosage of medication to be taken, or instructions for taking such medication for the benefit of the aged or sight impaired. In such case, the audio clip is stored in memory in the electronic aid and correlated to the identifiers coded on such data carriers. With respect to use of data carriers on the pages of a printed book, the information to be read aloud is generally the words entered on the page to which the data carrier is affixed. With regard to the use of data carriers on pages of books or other educational materials, see applicant's pending U.S. application Ser. No. 13/189,868, the detailed description of which is incorporated herein by reference. The words are recorded into the memory of the electronic aid in correlation with the identifiers coded on the data carrier on the page in question and read by the electronic aid. The audio recording can then be replayed by reading the data carrier with the electronic aid for the benefit of a young child who is going to bed or an older child who is learning to read. The audio recording is associated with the particular identifier and stored in the electronic aid, along with a reference to identifier.

For example, U.S. patent application Ser. No. 12/989,426 discloses the use of labels with identifiers that can be affixed, for example, to food items in order to assist visually impaired individuals with article identification. With respect to the instant invention, data carriers can be used to read out information aloud that is stored in a handheld electronic aid such as the AnyBook™ Reader designed and sold by Franklin Electronic Publishers, Inc. that is mainly intended to facilitate a parent's desire to have his or her familiar voice be used to read aloud the words printed on the pages of a children's book for his or her child's enjoyment.

For decades, manufactures have produced sports trading sticker and trading cards. Typically, a trading sticker or card will feature a picture of an athlete (such as, for example, a member of a soccer, football or baseball team), provide information with respect to the athlete's affiliated team, and other relevant statistics corresponding to the athlete's performance, for that team or over the athlete's entire career. Typically, the small size of a sports trading sticker or card limits the amount of data that can be stored on the card or sticker. Similarly, trading stickers or cards of the type described in the prior art lack any means for utilizing social media to create dynamic content to be shared with others. A need, therefore, exists in the art to develop a trading sticker or card that can store additional information from a card or sticker owner and the manufacturer. A further need exists for a trading sticker or card that can incorporate dynamic content supplied by other aficionados to further annotate a trading sticker or card with other information deemed relevant to a sticker or card holder.

### SUMMARY OF THE INVENTION

According to the present invention, the foregoing and other objects and advantages are obtained by utilizing a method for sharing information related to collectable items in the form of digital audio or video files among a plurality of users in order to facilitate the reading aloud of audio messages or viewing of video messages associated with a unique data carrier on a collectible item using at least one handheld electronic aid, a computer, at least one server, and a network by which such computer and servers are integrated, comprising the following steps: (1) reading and storing the data encoded in a data carrier on a trading sticker within the memory of a handheld electronic aid connected to a computer; (2) transferring data corresponding to the data carrier from the memory of the handheld electronic aid to the memory of the computer via the connection; (3) uploading, by a user, data corresponding to the data carrier from the memory of the computer to the memory of a server via a network; (4) downloading, to a user, download data from the memory of the server linked to the corresponding data carrier to the memory of the computer associated with the data carrier; (5) transferring the download data from the memory of the server linked to the corresponding data carrier downloaded to the memory of the computer to the memory of the handheld electronic aid via the said connection, and; (6) scanning the data carrier by the user with the handheld electronic aid whereby the download data associated with the identifier is recalled from the memory of the handheld electronic aid and the download data is output as audio from a speaker on the handheld electronic aid.

According to another aspect of the invention, the collectable item is selected from the group consisting of soccer trading stickers, soccer trading cards, baseball trading stickers, baseball trading cards, football trading stickers, football trading cards, coins, comic books, jelly jam jars, stamp books, magazines, old books, and albums.

According to other aspects of the invention, the computer is a tablet computer, personal computer, or smartphone.

According to other aspects of the invention, the connection is established by a wireless radio frequency, by BLUETOOTH, or by a cable.

According to another aspect of the invention, the computer has an application software program running therein that controls a desktop on the computer.

According to another aspect of the invention, the uploading is accomplished through the operation of an internet web browser via the internet.

According to another aspect of the invention, the downloading is accomplished through the operation of an internet web browser via the internet.

According to another aspect of the invention, there is a method for sharing information related to collectible items in the form of digital audio files among a plurality of users in order to facilitate the reading aloud of audio messages associated with a unique data carrier on at least one collectible item using at least one handheld electronic aid, at least one computer, at least one server, and a network by which such computers and servers are integrated, comprising the steps of: (1) reading and storing the data encoded in a data carrier on a trading sticker within the memory of a handheld electronic aid connected to a computer; (2) recording and storing sound in the memory of a handheld electronic aid by a user via a microphone on the handheld electronic aid adapted to the memory of the handheld electronic aid; (3) transferring data corresponding to the data carrier from the memory of the handheld electronic aid, along with the sound recording and data linking the data carrier and the sound recording to the memory of the computer via the connection; (4) uploading, by a user, data corresponding to the data carrier, along with the sound recording and data linking the data carrier and the sound recording from the memory of the computer to the memory of a server via a network; (5) downloading, by a second user, data corresponding to the sound recording from the memory of a server via a network to the memory of a second computer; (6) transferring the download sound recording from the memory of the second computer to the memory of a second handheld electronic aid via a connection between the second computer and the second handheld electronic aid; (7) scanning a data carrier on a second trading sticker by the second user with the second handheld electronic aid and associating the download sound recording the identifier on the second trading sticker such that a subsequent scanning of the data carrier on the second trading sticker by the second user with the second handheld electronic aid will replay the associated sound recording on a microphone on the second handheld electronic aid.

According to another aspect of the invention, the collectable item is selected from the group consisting of soccer trading stickers, soccer trading cards, baseball trading stickers, baseball trading cards, football trading stickers, football trading cards, coins, comic books, jelly jam jars, stamp books, magazines, old books, and albums.

According to another aspect of the invention, the computer is a tablet computer, personal computer or smartphone.

According to other aspects of the invention, the connection is established by a wireless radio frequency, by BLUETOOTH, or by a cable.

According to another aspect of the invention, the computer has an application software program running therein that controls a desktop on the computer.

According to another aspect of the invention, the uploading is accomplished through the operation of an internet web browser via the internet.

According to another aspect of the invention, the downloading is accomplished through the operation of an internet web browser via the internet.

According to another aspect of the invention, there is a method for sharing information related to collectible items in the form of digital video, graphic, or text files among a plurality of users in order to facilitate the viewing of video, graphic, or text messages associated with a unique data carrier on at least one collectible item using at least one handheld electronic aid, at least one computer, at least one server, and a network by which such computers and servers are integrated, comprising the steps of: (1) reading and storing the first identifier encoded in a first data carrier on a first collectible item within the memory of a first handheld electronic aid connected to a first computer; (2) storing a video, graphic, or text recording in the memory of the said first handheld electronic aid by a first collector via the said connection to a first computer where the said video, graphic, or text recording was previously recorded in the memory of the said first computer; (3) transferring data corresponding to the said first identifier on the said first data carrier from the memory of the said first handheld electronic aid, along with the said video, graphic, or text recording and data linking the said first data carrier and the video, graphic, or text recording to the memory of the first computer via the said connection; (4) uploading, by a collector, data corresponding to the said first identifier on the said first data carrier, along with the said video, graphic, or text recording and the said data linking the said first data carrier and the said video, graphic, or text recording from the memory of the said first computer to the memory of a server via a network; (5) downloading, by a second collector, data corresponding to the said video, graphic, or text recording from the memory of the said server via a network to the memory of a second computer; (6) transferring the said download video, graphic, or text recording from the memory of the said second computer to the memory of a second handheld electronic aid via a connection between the second computer and the second handheld electronic aid; (7) scanning a second data carrier on a second trading sticker by said second user with said second handheld electronic aid and associating the download video, graphic, or text recording with the second identifier on the second trading sticker such that a subsequent scanning of the said second data carrier on the said second trading sticker by the said second user with the said second handheld electronic aid will replay the associated video, graphic, or text recording on a display screen on the said second handheld electronic aid.

According to another aspect of the invention, the collectible item is selected from the group consisting of soccer trading stickers, soccer trading cards, baseball trading stickers, baseball trading cards, football trading stickers, football trading cards, coins, comic books, jelly jars, stamp books, magazines, old books, records, record albums and albums.

According to another aspect of the invention, the computer is a tablet computer, personal computer, or smartphone.

According to another aspect of the invention, the connection is established by wireless radio frequency, BLUETOOTH, or USB cable.

According to another aspect of the invention, the computer has an application software program running therein that controls a desktop on the computer.

According to another aspect of the invention, the uploading is accomplished through the operation of an internet web browser via the internet.

According to another aspect of the invention, the downloading is accomplished through the operation of an internet web browser via the internet.

According to another aspect of the invention, there is a method for sharing information related to collectible items in the form of digital audio, graphical, textual, and/or video files among a plurality of collectors in order to facilitate the reading aloud of audio messages or playing of video messages associated with a unique data carrier on a collectible item using at least one handheld electronic aid, a computer, at least one server, and a network by which such computer and servers are integrated, comprising the steps of: (1) reading and storing the identifier encoded in a data carrier on a collectible item in the memory of a handheld electronic aid connected to a computer; (2) transferring data corresponding to the said identifier on the said data carrier from the said memory of the said handheld electronic aid to the memory of the said computer via the said connection; (3) uploading, by a collector, the said data corresponding to the said identifier on the said data carrier from the memory of the said computer to the memory of a server via a network; (4) streaming graphical, text, audio and video files corresponding to the said identifier on the said data carrier from the said server on the desktop of the said computer; (5) downloading, by a collector, an audio file from the memory of the said server linked to the said data corresponding to the said identifier on the said data carrier to the memory of the said computer; (6) transferring the said audio file from the memory of the said server linked to the said corresponding identifier on the said data carrier downloaded to the memory of the said computer to the memory of the said handheld electronic aid via the said connection, and; (7) scanning the said data carrier by said collector with said handheld electronic aid whereby the said audio file associated with the said identifier is recalled from the memory of the handheld electronic aid and the said audio file is output as audio information from a speaker on the handheld electronic aid.

According to another aspect of the invention, the collectible item is selected from the group consisting of soccer trading stickers, soccer trading cards, baseball trading stickers, baseball trading cards, football trading stickers, football trading cards, coins, comic books, jelly jars, stamp books, magazines, old books, records, record albums and albums.

According to another aspect of the invention, the computer is a tablet computer, personal computer or smartphone. According to another aspect of the invention, the connection is established by a wireless radio frequency, by BLUETOOTH, or by a USB cable.

According to another aspect of the invention the computer has an application software program running therein that controls a desktop on the computer.

According to another aspect of the invention, the uploading and downloading are accomplished through the operation of an internet web browser via the internet.

Other details, objects, and advantages of the present invention will become apparent as the following description of the presently preferred embodiment and presently preferred method of practicing the invention proceeds.

### BRIEF DESCRIPTION OF THE DRAWINGS

The invention will become more readily apparent from the following description of the preferred embodiment thereof shown, by way of example only, in the accompanying drawings wherein:

FIG. 1 is a perspective view of a trading sticker according to one embodiment of the invention;

FIG. 2 is a perspective view of a handheld electronic aid for reading aloud information correlated to identifiers printed on data carriers in accordance with the present invention;

FIG. 3 is screenshot of a desktop under the control of an application software program running on a local computer according to one embodiment of the invention; and

FIG. 4 is a block diagram according to one embodiment of the invention.

### DETAILED DESCRIPTION OF THE INVENTION

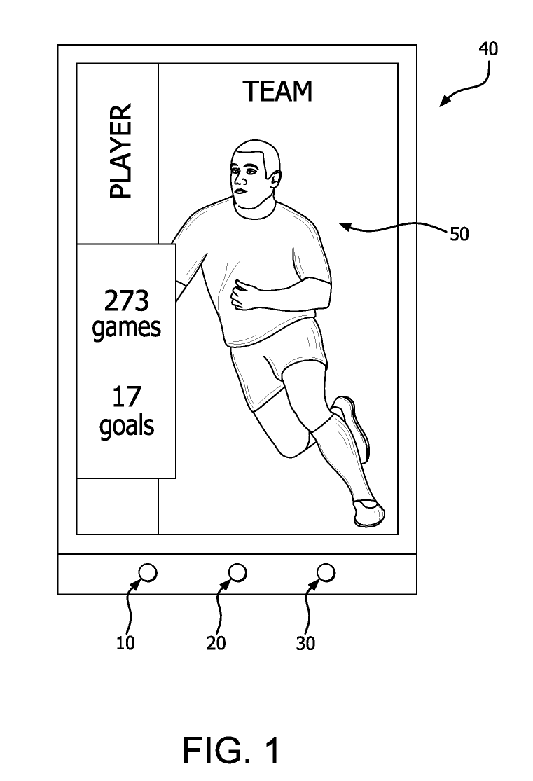

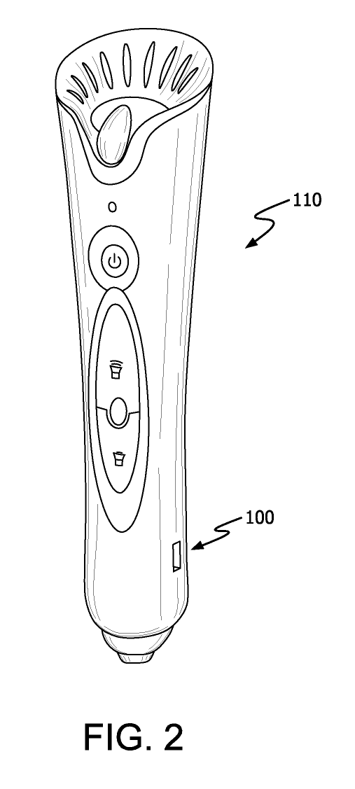

Referring to the drawings wherein like or similar references indicate like or similar elements throughout the several views, there is shown in FIG. 1 a trading sticker, generally identified by reference numeral 40. In another embodiment of the invention, a trading card is also used as an alternative to a trading sticker. The trading sticker or card features a picture of an athlete 50. In other embodiments, the individual depicted on trading sticker 40 could be an entertainer, actor, cartoon character, or political figure, for example. Trading sticker 40 also features three data carriers printed on the trading sticker 40. Data carriers consist of identifiers. Identifiers can take the form of one or more dot patterns that can be read by a handheld electronic aid adapted for that purpose, as described in U.S. patent application Ser. No. 13/425,063, the detailed description of which is incorporated herein by reference, and as depicted in FIG. 2, generally identified by reference numeral 110.

The first data carrier depicted on trading sticker 40 is the publisher data carrier 10. As explained further herein, this data carrier is utilized by the trading sticker manufacturer to record an audio, graphical, textual and/or video message linked in the handheld electronic aid 110 memory to the dot pattern in publisher data carrier 10, such that the handheld electronic aid 110 will play the recorded audio and/or video message corresponding to the dot pattern after the dot pattern is scanned by the handheld electronic aid 110. For example, the manufacturer may provide further marketing information to the trading sticker owner. Additional factual information can also be provided to the trading sticker owner.

The second data carrier depicted on trading sticker 40 is the user data carrier 20. As explained further herein, this data carrier is utilized by the trading sticker owner to record an audio, graphical, textual, and/or videomessage linked in the handheld electronic aid 110 memory to the dot pattern in user data carrier 20, such that the handheld electronic aid 110 will play the recorded audio, graphical, textual, and/or videomessage corresponding to the dot pattern after the dot pattern is scanned by the handheld electronic aid 110. For example, the user may record additional factual information about player 50.

The third data carrier depicted on trading sticker 40 is the social media data carrier 30. As explained further herein, this data carrier is utilized by the trading sticker owner to record an audio, graphical, textual, and/or video message linked in the handheld electronic aid 110 memory to the dot pattern in social media data carrier 30, such that the electronic aid will play the recorded audio, graphical, textual, and/or video message corresponding to the dot pattern after the dot pattern is scanned by the handheld electronic aid 110. For example, a user may download audio, graphical, textual, and/or video commentary from other users connected over the internet and the associate social media data carrier 30 with that audio, graphical, textual, and/or video file such that it can be recalled and played when the dot pattern in social media data carrier 30 is scanned with the handheld electronic aid 110.

FIG. 2 depicts a handheld electronic aid 110. The electronic aid has USB port 100 to facilitate a connection with, for example, a personal computer. Handheld electronic aid also has a speaker to play audio files (not depicted). In another embodiment (not depicted), the handheld electronic aid 110 also incorporates a video display screen, capable of displaying video files, graphical images or text data.

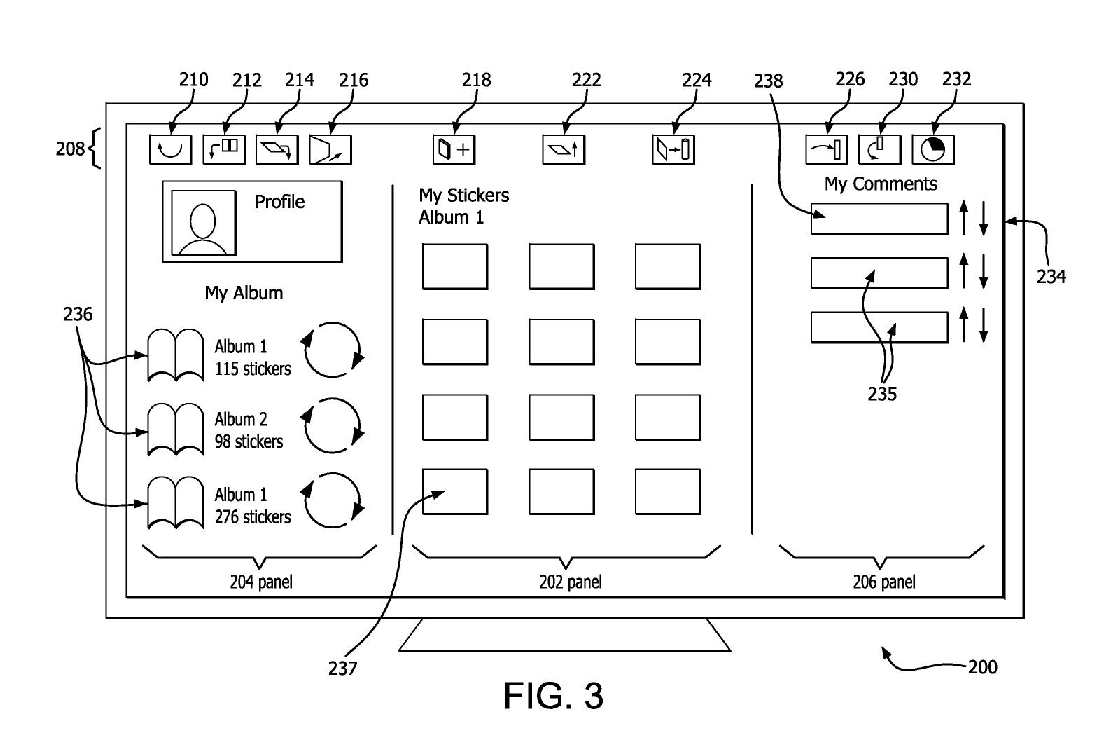

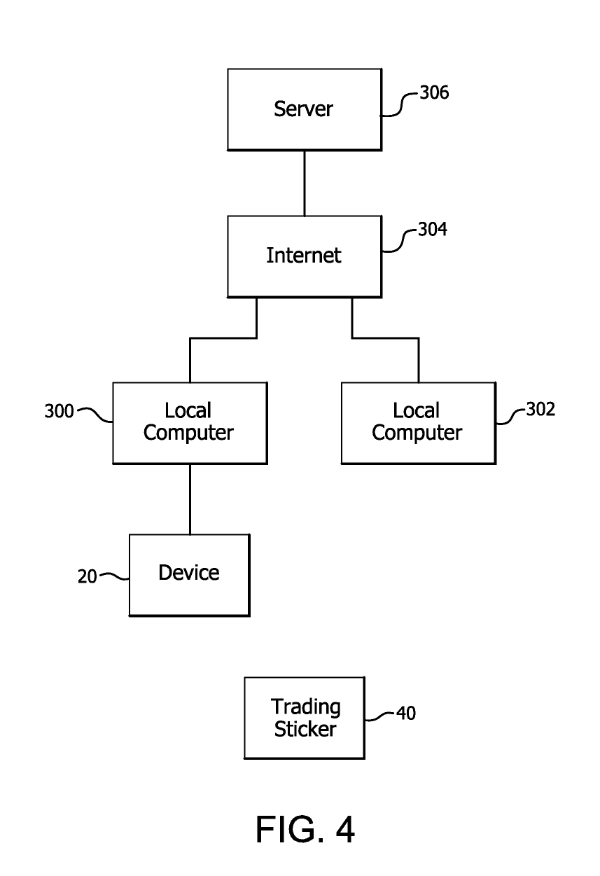

The preferred embodiment of the invention, as shown in FIG. 3, is centered on a control panel for the linking of data carriers on a network, such as the Internet, which is depicted as a desktop 200 that is provided on the screen of a personal computer, tablet computer, or smartphone used by one or both of the following: (i) a user and possessor of a handheld electronic aid 110, as shown in FIG. 2, or; (ii) a content provider of digital audio, graphical, textual, and/or video files (as may be referred to herein as “content”) that are intended to be stored in one or more of such handheld electronic devices to have read aloud (or viewed, in the case of video, graphics, and text) in correlation with identifiers that have been that have been printed on data carriers affixed to trading sticker 40. Such desktop is under the control of an application software computer program running on said personal computer, tablet computer or smartphone (hereinafter, any one of the three being referred to as a “local computer” such as block 300 as labeled in FIG. 4) and is three part in nature, having section 204 tracking and identifying content that is stored in the memory of said local computer. Section 204 illustrates the panel showing each of three example album icons 236, each with a given number representing the number of trading stickers 40 classified within each album. The term “stickers” is synonymous with the trading stickers in this context. An album may be, for example, a broad categorization of a team within a given year. Each constituent sticker within an album may be, for example, the corresponding members of the team.

The next panel 202 represents an index with thumbnail sized graphics illustrating each sticker within a selected album. Lastly, the final panel 206 illustrates a list of audio, graphical, textual, and/or video comments recorded by the user or obtained from social media via the internet in accord with the method disclosed herein.

Desktop 200 is comprised, in part, of a row of function icons 208 that allow the desktop user to control the program's operation. Each icon allows the user to click on (or touch) an icon to control a programmed operation. The functions for these icons are best exemplified in the preferred method of operation. In the preferred embodiment, the user connects handheld electronic aid 110 to a local computer 300 by means of USB port 100. In an alternative embodiment, the connection to the local computer 300 is established by BLUETOOTH (not depicted) or any other means of connection used to facilitate data communication between the local computer 300 and the handheld electronic aid 110 known to those having ordinary skill in the art.

If a user should acquire one or more trading sticker 40, the user can load information corresponding to the trading sticker into the local computer 300 by using the handheld electronic aid 110 to scan the publisher data carrier 10 on the trading sticker 40. Next, icon 214 on desktop 200 is clicked (or touched) to call the download module of the program. This action populates data into panel 204 to reflect the addition of a new sticker in its associated album. This occurs as a result of having an identical publisher data carrier 10 on each identical copy of a trading sticker 40 featuring a player 50. The dot pattern on each data carrier corresponds to a serial number the application program decodes in accordance with a pre-programmed algorithm. As depicted in FIG. 4, the local computer 300 communicates with server 306 via the internet 304 to locate publisher data corresponding to the serial number encoded on publisher data carrier 10 and then downloads that information from server 306 to local computer 300 via the internet 304. This data includes, among other things, information necessary to assign the given sticker to a given album, the textual identification of the given sticker and album, thumbnail images for the given trading sticker 40 and the content of the publisher's audio, graphical, textual, and/or video recording associated with publisher data carrier 10. All of this information is stored in the memory of the local computer 300.

In one embodiment, while the user is operating local computer 300 in communication with server 306 via the internet 304 to access publisher data corresponding to publisher data carrier 10, other correlated information can be viewed on desktop 200. Such correlated information includes graphical, video or audio information which can be streamed via the internet 300, but without downloading the correlated information into the memory of local computer 300 in the manner herein described. This correlated information may also take the form of links to other web sites on the internet 304. Such links may take a user to another website or a streaming video on a third-party website.

At any time, icon 210 on desktop 200 can be clicked (or touched) to refresh the view of the albums and stickers on desktop 200 to reflect the information currently stored on the local computer 300. In other embodiments, the program automatically refreshes after each action.

It may be necessary for a user to delete a trading sticker 40 from an album. Perhaps this is necessitated if a user trades a trading sticker to another individual. This is accomplished, for example, by having the user first click (or touch) an album number on panel 204. This action is programmed to trigger the display of the selected album and stickers in panel 202. The user can then click (or touch) an icon representing the thumbnail image of the trading sticker 40 the user desires to remove from a given album. Next, icon 212 on desktop 200 can be clicked (or touched) to delete this trading sticker from the memory of the local computer 300.

A user may then desire to record the user's own audio, graphical, textual, and/or video content and associate that content with the serial number coded on user data carrier 20. This process begins with the user using handheld electronic aid 110 to scan the user data carrier 20. In the preferred embodiment, an audio record button on handheld electronic aid 110 is then actuated (not depicted). In another embodiment, audio or video recording is initiated by clicking (or touching) icon 218 on desktop 200. (In another embodiment, the local computer 300 is adapted with a microphone to receive and store audio files within the memory of the local computer 300 and/or adapted with a video camera to receive and store video files within the memory of the local computer 300 and/or adapted with data saved in a file system on computer 300 representing graphical or textual information.) In the preferred embodiment, the user may then speak into a microphone on the handheld electronic aid 110 (not depicted) to record audio content for a given amount of time. In the case of video recording, the user may use local computer 300 (with its adapted video camera) to record a video message. In the case of graphic or text information, the user may use local computer 300 to recall such information from the stored memory and file system within local computer 300. The audio record button is again actuated to signal to the handheld electronic aid 110 that the recording is complete. In another embodiment the recording is stopped by clicking (or touching) icon 218 on desktop 200. The handheld electronic aid 110 is in data communication with the local computer 300. The local computer 300 stores the content and the association to the serial number encoded on the dot pattern for user data carrier 20 in the local computer 300 memory. The same information is stored within the memory of the handheld electronic aid 110.

Once the user recording is made, an icon 235 representing the user's recording appears in panel 206.

If the user desires to delete the audio, graphical, textual, and/or video recording referenced above, the icon 235 corresponding to the trading sticker 40 is clicked (or touched) in panel 202, thereby causing the associated icons representing the user's recording (or recordings) to appear in panel 206. The icon representing the user's recording to be deleted in panel 206 is then clicked (or touched) and icon 230 is then clicked (or touched), thereby removing the audio, graphical, textual, and/or video content and the link between the audio, graphical, textual, and/or video content and the serial number encoded in the dot pattern from the memory of the handheld electronic aid 110. Alternatively, icon 212 can be clicked (or touched) on desktop 200 to remove the audio, graphical, textual, and/or video content and the link between the audio, graphical, textual, and/or video content and the serial number encoded in the dot pattern from the memory of the local computer 300.

If the user desires to retain the user's audio, graphical, textual, and/or video recording and further upload the user's audio, graphical, textual, and/or video recording to a central sever 306 by way of the internet 304 (as depicted in FIG. 4), the user may select the album icon 236 in panel 204 on desktop 200 corresponding to the trading sticker 40 containing the user recorded audio, graphical, textual, and/or video clip. This causes icons 235 representing the user's recording (or recordings) to appear in panel 206. The user recording the user desires to upload can then be clicked (or touched). Next, icon 222 is clicked (or touched) to upload the selected user audio, graphical, textual, and/or video content and the associated serial number from local computer 300 to server 306 via the internet 304. The user's audio, graphical, textual, and/or video recording is now available for other users to download in the manner described below.

If a user desires to download another user's audio, graphical, textual, and/or video file for a particular trading sticker 40, this can be accomplished by selecting the thumbnail image 237 on panel 202 corresponding to the trading sticker 40 for which the user desires to associate with one or more audio, graphical, textual, and/or video files from another user. Next, icon number 214 is clicked (or touched), thereby causing panel 206 to be populated with images corresponding to audio and/or video files from other users 238. Panel 206 receives this information from the server 306 through the internet 304. A user may then click (or touch) the symbols corresponding to another user's audio and/or video files 238. The audio, graphical, textual, and/or video files 238 may have, for example originated on another local computer 302 (as depicted in FIG. 4) from another user. Such other user audio, graphical, textual, and/or video files 238 from another local computer 302 were uploaded to the server 306 via the internet 304, which then permitted the user operating local computer 300 to download the other user's audio, graphical, textual, and/or video files from the server 306 via the internet 304.

After the user clicks (or touches) a symbol corresponding to another user's audio, graphical, textual, and/or video files 238, the audio, graphical, textual, and/or video file begins to stream (or be displayed) from the internet 304. A user may indicate whether they like or dislike a particular audio, graphical, textual, and/or video file from another user by clicking (or touching) the appropriate icon 234 adjacent to the icons on panel 206 of desktop 200. In this manner, every user on the system can collectively prioritize comments based on the sum of their collective votes. Accordingly, the most liked comments from other users appear at the top of the list and the most disliked comments are numerically ordered beneath the popular comments in panel 206.

A user may then desire to download the content of another user's audio, graphical, textual, and/or video file 238 onto the local computer 300 and the handheld electronic aid 110, such that the content can be associated with the social media data carrier 30 on trading sticker 40. This is accomplished by clicking (or touching) the icon in panel 206 representing another user's audio or video file 238. In other examples, one or more icon 238 can be selected in order to download a plurality of other user audio, graphical, textual, and/or video files 238. Next, icon 214 is clicked (or touched) to initiate a download of the corresponding audio, graphical, textual, and/or video files onto the local computer 300 from sever 306 via internet 304. The connected handheld electronic aid 110 also receives this information either automatically, or, in a preferred embodiment, by clicking (or touching) icon 224. Next, the handheld electronic aid 110 is used to read the social media data carrier 30, thereby establishing a link between the saved audio or video file(s) and the serial number encoded on the social media data carrier 30 within the memory of the handheld electronic aid 110. The information regarding the said linkage is also simultaneously stored within the memory of local computer 300 via the paired connection of handheld electronic aid 110 and local computer 300.

If a user desires to restore data saved in the memory of the local computer 300 onto the memory of the handheld electronic aid 110, the user may connect the handheld electronic aid 110 to the local computer 300 in the manner described herein and then select icon 226 from desktop 200, thereby causing the execution of a module that copies the data saved within the memory of a local computer 300 onto the memory of the handheld electronic aid 110. Similarly, in another embodiment, additional handheld electronic aids 110 can be similarly stored with information from the local computer 300 by connecting each handheld electronic aid 110 to the local computer 300 in the manner herein described and utilizing the same module called by icon 226.

Icon 232 on desktop 200 is clicked (or touched) in the case that the user of desktop 200 desires to disconnect the USB connection between local computer 300 and handheld electronic aid 110 without losing any content stored either in such local computer 300 memory or the memory of said handheld electronic device 110.

It is understood that this invention can be practiced with any collectable item, not just trading stickers or cards. The data carriers can be printed on or affixed to coins, comic books, jelly jam jars, stamp books, magazines, old books, albums, or any other tangible object an individual may collect.

What is claimed is:

1. A method for sharing information related to collectible items in the form of digital audio, graphical, textual, and/or video files among a plurality of collectors in order to facilitate the reading aloud of audio messages or playing of video messages associated with a unique data carrier on a collectible item using at least one handheld electronic aid, a computer, at least one server, and a network by which such computer and servers are integrated, comprising the steps of:
reading and storing the identifier encoded in a data carrier on a collectible item in the memory of a handheld electronic aid connected to a computer;
transferring data corresponding to the said identifier on the said data carrier from the said memory of the said handheld electronic aid to the memory of the said computer via the said connection;
uploading, by a collector, the said data corresponding to the said identifier on the said data carrier from the memory of the said computer to the memory of a server via a network;
downloading, by a collector, download data from the memory of the said server linked to the said data corresponding to the said identifier on the said data carrier to the memory of the said computer;
transferring the said download data from the memory of the said server linked to the said corresponding identifier on the said data carrier downloaded to the memory of the said computer to the memory of the said handheld electronic aid via the said connection;
scanning the said data carrier by said collector with said handheld electronic aid whereby the said download data associated with the said identifier is recalled from the memory of the handheld electronic aid and the said download data is output as audio information from a speaker on the handheld electronic aid or as video information from a video screen on a handheld electronic aid.

2. The method of claim 1 in which the collectible item is selected from the group consisting of soccer trading stickers, soccer trading cards, baseball trading stickers, baseball trading cards, football trading stickers, football trading cards, coins, comic books, jelly jars, stamp books, magazines, old books, records, record albums and albums.

3. The method of claim 2 wherein the download data comprises an audio file and a linkage between the said audio file and the said identifier.

4. The method of claim 2 wherein the download data comprises a video, graphical, or text file and a linkage between the said video, graphical, or text file and the said identifier.

5. The method of claim 2 in which the said computer is a tablet computer.

6. The method of claim 2 in which the said computer is a personal computer.

7. The method of claim 2 in which the said computer is a smartphone.

8. The method of claim 2 in which said connection is established by a wireless radio frequency.

9. The method of claim 2 in which said connection is established by BLUETOOTH.

10. The method of claim 2 in which said connection is by a USB cable.

11. The method of claim 2 in which the computer has an application software program running therein that controls a desktop on the computer.

12. The method of claim 2 in which said uploading is accomplished through the operation of an internet web browser via the internet.

13. The method of claim 2 in which said downloading is accomplished through the operation of an internet web browser via the internet.

14. A method for sharing information related to collectible items in the form of digital audio files among a plurality of users in order to facilitate the reading aloud of audio messages associated with a unique data carrier on at least one collectible item using at least one handheld electronic aid, at least one computer, at least one server, and a network by which such computers and servers are integrated, comprising the steps of:
reading and storing the first identifier encoded in a first data carrier on a first collectible item within the memory of a first handheld electronic aid connected to a first computer;
recording and storing sound in the memory of the said first handheld electronic aid by a first collector via a microphone on the said first handheld electronic aid adapted to the memory of the said first handheld electronic aid;
transferring data corresponding to the said first identifier on the said first data carrier from the memory of the said first handheld electronic aid, along with the said sound recording and data linking the said first data carrier and the sound recording to the memory of the first computer via the said connection;
uploading, by a collector, data corresponding to the said first identifier on the said first data carrier, along with the said sound recording and the said data linking the said first data carrier and the said sound recording from the memory of the said first computer to the memory of a server via a network;
downloading, by a second collector, data corresponding to the said sound recording from the memory of the said server via a network to the memory of a second computer;
transferring the said download sound recording from the memory of the said second computer to the memory of a second handheld electronic aid via a connection between the second computer and the second handheld electronic aid;
scanning a second data carrier on a second trading sticker by said second user with said second handheld electronic aid and associating the download sound recording with the second identifier on the second trading sticker such that a subsequent scanning of the said second data carrier on the said second trading sticker by the said second user with the said second handheld electronic aid will replay the associated sound recording on a microphone on the said second handheld electronic aid.

15. The method of claim 14 in which the collectible item is selected from the group consisting of soccer trading stickers, soccer trading cards, baseball trading stickers, baseball trading cards, football trading stickers, football trading cards, coins, comic books, jelly jars, stamp books, magazines, old books, records, record albums and albums.

16. The method of claim 14 in which the computer is a tablet computer.

17. The method of claim 14 in which the computer is a personal computer.

18. The method of claim 14 in which the computer is a smartphone.

19. The method of claim 14 in which said connection is established by wireless radio frequency.

20. The method of claim 14 in which said connection is established by BLUETOOTH.

21. The method of claim 14 in which said connection is by a USB cable.

22. The method of claim 14 in which the computer has an application software program running therein that controls a desktop on the computer.

23. The method of claim 14 in which said uploading is accomplished through the operation of an internet web browser via the internet.

24. The method of claim 14 in which said downloading is accomplished through the operation of an internet web browser via the internet.

25. A method for sharing information related to collectible items in the form of digital video, graphical, or text files among a plurality of users in order to facilitate the viewing of video, graphical, or text messages associated with a unique data carrier on at least one collectible item using at least one handheld electronic aid, at least one computer, at least one server, and a network by which such computers and servers are integrated, comprising the steps of:
reading and storing the first identifier encoded in a first data carrier on a first collectible item within the memory of a first handheld electronic aid connected to a first computer;
storing a video, graphical or text recording in the memory of the said first handheld electronic aid by a first collector via the said connection to a first computer where the said video, graphical, or text recording was previously recorded in the memory of the said first computer;
transferring data corresponding to the said first identifier on the said first data carrier from the memory of the said first handheld electronic aid, along with the said video, graphical, or text recording and data linking the said first data carrier and the video, graphical, or text recording to the memory of the first computer via the said connection;
uploading, by a collector, data corresponding to the said first identifier on the said first data carrier, along with the said video, graphical, or text recording and the said data linking the said first data carrier and the said video, graphical, or text recording from the memory of the said first computer to the memory of a server via a network;
downloading, by a second collector, data corresponding to the said video, graphical, or text recording from the memory of the said server via a network to the memory of a second computer;
transferring the said download video, graphical, or text recording from the memory of the said second computer to the memory of a second handheld electronic aid via a connection between the second computer and the second handheld electronic aid;
scanning a second data carrier on a second trading sticker by said second user with said second handheld electronic aid and associating the download video, graphical, or text recording with the second identifier on the second trading sticker such that a subsequent scanning of the said second data carrier on the said second trading sticker by the said second user with the said second handheld electronic aid will replay the associated video, graphical, or text recording on a display screen on the said second handheld electronic aid.

26. The method of claim 25 in which the collectible item is selected from the group consisting of soccer trading stickers, soccer trading cards, baseball trading stickers, baseball trading cards, football trading stickers, football trading cards, coins, comic books, jelly jars, stamp books, magazines, old books, records, record albums and albums.

27. The method of claim 25 in which the computer is a tablet computer.

28. The method of claim 25 in which the computer is a personal computer.

29. The method of claim 25 in which the computer is a smartphone.

30. The method of claim 25 in which said connection is established by wireless radio frequency.

31. The method of claim 25 in which said connection is established by BLUETOOTH.

32. The method of claim 25 in which said connection is by a USB cable.

33. The method of claim 25 in which the computer has an application software program running therein that controls a desktop on the computer.

34. The method of claim 25 in which said uploading is accomplished through the operation of an internet web browser via the internet.

35. The method of claim 25 in which said downloading is accomplished through the operation of an internet web browser via the internet.

36. A method for sharing information related to collectible items in the form of digital audio, graphical, textual, and/or video files among a plurality of collectors in order to facilitate the reading aloud of audio messages or playing of video messages associated with a unique data carrier on a collectible item using at least one handheld electronic aid, a computer, at least one server, and a network by which such computer and servers are integrated, comprising the steps of:
reading and storing the identifier encoded in a data carrier on a collectible item in the memory of a handheld electronic aid connected to a computer;
transferring data corresponding to the said identifier on the said data carrier from the said memory of the said handheld electronic aid to the memory of the said computer via the said connection;
uploading, by a collector, the said data corresponding to the said identifier on the said data carrier from the memory of the said computer to the memory of a server via a network;
streaming graphical, text, audio and video files corresponding to the said identifier on the said data carrier from the said server on the desktop of the said computer;
downloading, by a collector, an audio file from the memory of the said server linked to the said data corresponding to the said identifier on the said data carrier to the memory of the said computer;
transferring the said audio file from the memory of the said server linked to the said corresponding identifier on the said data carrier downloaded to the memory of the said computer to the memory of the said handheld electronic aid via the said connection;
scanning the said data carrier by said collector with said handheld electronic aid whereby the said audio file associated with the said identifier is recalled from the memory of the handheld electronic aid and the said audio file is output as audio information from a speaker on the handheld electronic aid.

37. The method of claim 36 in which the collectible item is selected from the group consisting of soccer trading stickers, soccer trading cards, baseball trading stickers, baseball trading cards, football trading stickers, football trading cards, coins, comic books, jelly jars, stamp books, magazines, old books, records, record albums and albums.

38. The method of claim 36 in which the said computer is a tablet computer.

39. The method of claim 36 in which the said computer is a personal computer.

40. The method of claim 36 in which the said computer is a smartphone.

41. The method of claim 36 in which said connection is established by a wireless radio frequency.

42. The method of claim 36 in which said connection is established by BLUETOOTH.

43. The method of claim 36 in which said connection is by a USB cable.

44. The method of claim 36 in which the computer has an application software program running therein that controls a desktop on the computer.

45. The method of claim 36 in which said uploading is accomplished through the operation of an internet web browser via the internet.

46. The method of claim 36 in which said downloading is accomplished through the operation of an internet web browser via the internet.
